(19) United States
(12) Patent Application Publication
(10) Pub. No.: US 2022/0176708 A1
(43) Pub. Date: Jun. 9, 2022

(54) CIRCULATION PATH FOR BUBBLER

(71) Applicant: Hewlett-Packard Development Company, L.P., Spring, TX (US)

(72) Inventors: Boon Bing Ng, Vancouver, WA (US); Anthony M. Fuller, Corvallis, OR (US); Michael W. Cumbie, Corvallis, OR (US)

(73) Assignee: Hewlett-Packard Development Company, L.P., Spring, TX (US)

(21) Appl. No.: 17/417,789

(22) PCT Filed: Aug. 28, 2019
(86) PCT No.: PCT/US2019/048499

§ 371 Date: Jun. 24, 2021

(51) Int. Cl. B41J 2/19; B41J 2/14

(52) U.S. Cl. CPC B41J 2/19; B41J 2202/12; B41J 2/1404

(57) ABSTRACT

In some examples, a fluid dispensing device includes an inner chamber to contain a fluid. The fluid dispensing device further includes an orifice layer comprising a bubbler orifice to draw air through a bubbler chamber to the inner chamber responsive to a pressure satisfying a criterion, the bubbler chamber being adjacent the bubbler orifice. A circulation path circulates fluid drawn through a feed hole through the bubbler chamber.

### BACKGROUND

A fluid dispensing system can dispense fluid towards a target. In some examples, a fluid dispensing system can include a printing system, such as a two-dimensional (2D) printing system or a three-dimensional (3D) printing system. A printing system can include printhead devices that include fluidic actuators to cause dispensing of printing fluids.

### BRIEF DESCRIPTION OF THE DRAWINGS

Some implementations of the present disclosure are described with respect to the following figures.

FIG. 1 is a schematic sectional side view of a printhead that includes a printhead die with a bubbler and a recirculation path for the bubbler according to some examples.

FIG. 2 is a graph that illustrates a relationship of a back pressure and a volume of fluid delivered from a fluid dispensing device, according to some examples.

FIGS. 3-7 are schematic bottom views of a portion of a nozzle array and a bubbler with a circulation path, according to various examples.

FIG. 8 is a schematic bottom view of a nozzle array and bubblers with circulation paths, according to further examples.

FIGS. 9 and 10 are block diagrams of fluid dispensing devices according to some examples.

FIG. 11 is a flow diagram of a process of forming a fluid dispensing device according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A fluid dispensing device can include fluidic actuators that when activated cause dispensing (e.g., ejection or other flow) of a fluid. A fluid can include a printing liquid (such as ink), or any other type of liquid. For example, the dispensing of the fluid can include ejection of fluid droplets by activated fluidic actuators from respective nozzles of the fluid dispensing device. In other examples, an activated fluidic actuator (such as a pump) can cause fluid to flow through a fluid conduit or fluid chamber. Activating a fluidic actuator to dispense fluid can thus refer to activating the fluidic actuator to eject fluid from a nozzle or activating the fluidic actuator to cause a flow of fluid through a flow structure, such as a flow conduit, a fluid chamber, and so forth.

Activating a fluidic actuator can also be referred to as firing the fluidic actuator. In some examples, fluidic actuators include thermal-based fluidic actuators including heating elements, such as resistive heaters. When a heating element is activated, the heating element produces heat that can cause vaporization of a fluid to cause nucleation of a vapor bubble (e.g., a steam bubble) proximate the thermal-based fluidic actuator that in turn causes dispensing of a quantity of fluid, such as ejection from an orifice of a nozzle or flow through a fluid conduit or fluid chamber. In other examples, a fluidic actuator may be a piezoelectric membrane based fluidic actuator that when activated applies a mechanical force to dispense a quantity of fluid.

In examples where a fluid dispensing device includes nozzles, each nozzle includes a fluid chamber, also referred to as a nozzle chamber or firing chamber. In addition, a nozzle can include an orifice through which fluid is dispensed, a fluidic actuator, and possibly a sensor. Each fluid chamber provides the fluid to be dispensed by the respective nozzle.

Generally, a fluidic actuator can be an ejecting-type fluidic actuator to cause ejection of a fluid, such as through an orifice of a nozzle, or a non-ejecting-type fluidic actuator to cause flow of a fluid.

In some examples, a fluid dispensing device can be in the form of a printhead, which can be mounted to a print cartridge, a carriage, a printbar, and so forth. In further examples, a fluid dispensing device can include a fluidic die, such as a printhead die used in printing operations. A “die” refers to an assembly where various layers are formed onto a substrate to fabricate circuitry, fluid chambers, and fluid conduits. Multiple fluidic dies can be mounted or attached to a support structure.

A fluid dispensing device, such as a printhead or another type of fluid dispensing device, may include a fluid reservoir that contains a fluid (e.g., a printing liquid such as ink, or another type of liquid). The fluid reservoir supplies the fluid that can be dispensed through the orifices of the fluid dispensing device in response to activation of fluidic actuators.

As the fluid dispensing device is used over time, a back pressure of the fluid dispensing device can increase. The back pressure can be expressed as the difference between the atmospheric pressure of the environment surrounding the fluid dispensing device and the pressure inside a fluid reservoir of the fluid dispensing device. As the fluid in the fluid reservoir is depleted, the back pressure resulting from the decreasing volume of the fluid in the fluid reservoir increases.

The back pressure may reach a high enough level such that fluid from the fluid reservoir flows less readily through the orifices of the fluid dispensing device, which leads to degraded operation of the fluid dispensing device. For example, if the fluid dispensing device is used in a printing operation of a printing system, then the increased back pressure can cause a noticeable degradation (noticeable to a user, for example) of the quality of printed images on a print substrate (e.g., paper, transparency, etc.). Also, the reduced flow of fluid from the fluid dispensing device can cause a premature or false low fluid indication to be provided for the fluid dispensing device, which can lead to premature replacement of the fluid dispensing device or fluid reservoir even though the fluid reservoir still has sufficient fluid to continue with fluid dispensing operations.

To extend the useful life of fluid dispensing devices, a bubbler can be implemented to provide back pressure regulation. The bubbler causes air to be drawn through a bubbler orifice of the fluid dispensing device so that air can be provided to the fluid reservoir of the fluid dispensing device, normalizing the back pressure. The bubbler orifice is larger than nozzle orifices. As a result, a decap issue can arise when the bubbler orifice is exposed to an outside environment (when a cap covering the orifices of the fluid dispensing device is removed to allow for fluid dispensing operations, such as printing operations, to occur). The decap issue is caused when water in the fluid (e.g., ink) of the fluid dispensing device evaporates. Evaporation of water from the fluid of the fluid dispensing device can leave a viscous soft plug in a bubbler chamber that is adjacent the bubbler orifice of the fluid dispensing device. The presence of the viscous soft plug in the bubbler chamber can cause the bubbler to not function effectively. For example, the presence of the viscous soft plug can cause the bubbler to not be able to draw in air effectively to counteract the issue of increased back pressure, which can lead to a premature end of life of the fluid dispensing device.

In accordance with some implementations of the present disclosure, a circulating mechanism or technique is provided to circulate fluid through a bubbler chamber to keep the fluid in the bubbler chamber fresh, to address the decap issue.

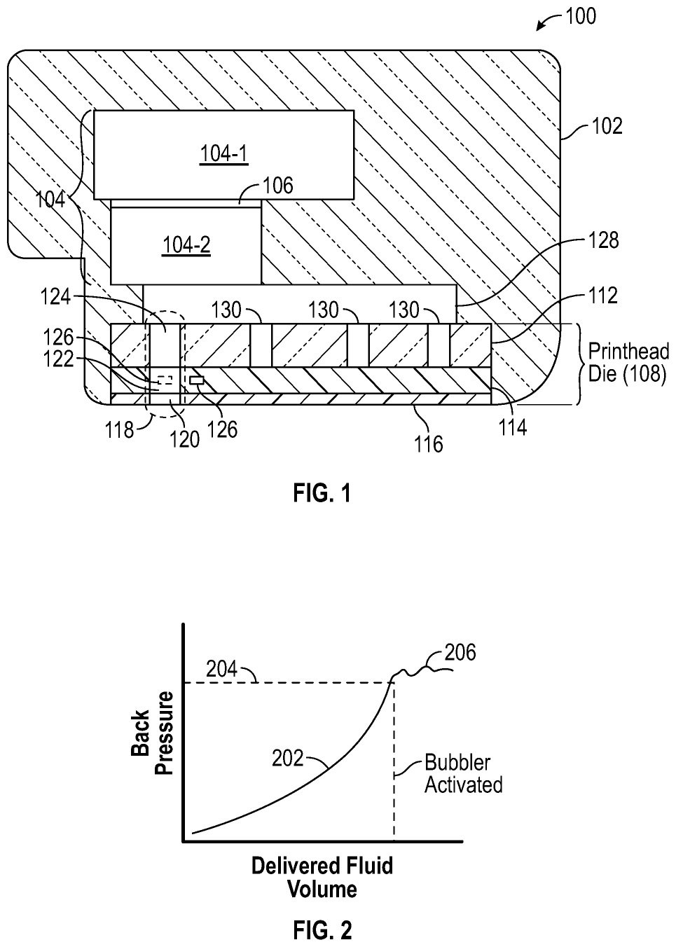

FIG. 1 is a schematic sectional side view of a printhead 100. Although reference is made to a printhead, it is noted that techniques or mechanisms according to some implementations of the present disclosure can be applied to other types of fluid dispensing devices.

The printhead 100 includes a printhead body 102 in which a fluid reservoir 104 is provided. The fluid reservoir 104 includes a first reservoir portion 104-1 and a second reservoir portion 104-2. In some examples, the first reservoir portion 104-1 can include a foam having pores in which fluid (e.g., a printing liquid) may reside. The second reservoir portion 104-2 can be referred to as a “stand pipe,” which is an inner chamber into which fluid from the first reservoir portion 104-1 can flow through a filter 106. The filter 106 prevents ingress of particulate material from the first reservoir portion 104-1 to the stand pipe 104-2.

The stand pipe 104-2 contains a sufficient volume of fluid to allow for fluid to be readily dispensed to fluid chambers of a printhead die 108, to be dispensed through orifices of the printhead die 108 in response to activation of respective fluidic actuators during a fluid dispensing operation.

Although FIG. 1 shows an example of a fluid reservoir 104 that is divided into reservoir portions 104-1 and 104-2, it is noted that in other examples, other types of fluid reservoirs can be included in the printhead 102.

The printhead die 108 is attached to a lower portion (in the view of FIG. 1) of the printhead body 102.

In some examples, the printhead die 108 is formed by over-molding a printhead die (or alternatively, multiple printhead dies) to form a composite printhead, each die containing its own bubbler for each fluid reservoir. The mold compound can include an epoxy molded compound (EMC), for example. In other examples, the mold compound can be a different material. In further examples, instead of a composite die, the printhead die 108 can be a monolithic substrate such as glass, silicon, etc.

In other examples, the printhead die 108 can be attached or mounted to the printhead body 102 using a different technique.

The printhead die 108 includes a die layer 112, which can include a layer (or multiple layers) of silicon or another semiconductor material, in some examples. Various elements can be formed using further layers in the die layer 112. For example, resistive heaters in the form of resistors (formed using electrically resistive materials) can be formed in the die layer 112. In other examples, if fluidic actuators are implemented with piezoelectric elements, then a piezoelectric material can be formed in the die layer 112. Electrically conductive structures can also be formed in the die layer 112 to connect fluidic actuators to other circuitry.

A chamber layer 114 is provided “on” the die layer 112. A chamber layer being provided “on” the die layer can refer to the chamber layer being attached or mounted to the die layer. During manufacturing of the printhead die 108, the printhead die 108 is formed by first forming the die layer 112, followed by forming the chamber layer 114 over the die layer 112, followed by forming an orifice layer 116 over the chamber layer 114. During use, the printhead die 108 is flipped in the upside-down orientation, as shown in FIG. 1.

Fluid chambers (not shown) for nozzles are formed in the chamber layer 114, and orifices (not shown) for the nozzles are formed in the orifice layer 116. In some examples, each of the chamber layer 114 and the orifice layer 116 can include epoxy or another material.

Each fluid chamber is formed in the chamber layer 114 adjacent a corresponding orifice in the orifice layer 116, such that upon activation of a respective fluidic actuator, fluid from the fluid chamber in the chamber layer 114 can be expelled through the orifice in the orifice layer 116, such as towards a target during a printing operation.

The printhead die 108 can include other layers that are not shown in FIG. 1.

In accordance with some implementations of the present disclosure, a bubbler 118 is provided in the printhead 100. The bubbler 118 includes a bubbler orifice 120 formed in the orifice layer 116. The bubbler 118 further includes a bubbler chamber 122 formed in the chamber layer 114. The bubbler chamber 122 is arranged to be adjacent the bubbler orifice 120 such that the bubbler orifice 120 is in fluid communication with the bubbler chamber 122.

The bubbler chamber 122 is in fluid communication with a bubbler fluid feed hole 124 that extends through the die layer 112. The bubbler fluid feed hole 124 is in fluid communication with a fluid slot 128 formed in the printhead body 102. The fluid slot 128 carries fluid from the stand pipe 104-2 to the printhead die 108, for delivery to fluid chambers in the printhead die 108.

In some examples, the bubbler orifice 120 has a selected dimension (e.g., a selected diameter, a selected area, etc.) that is designed to allow air to enter through the bubbler orifice 120 and through the bubbler chamber 122 and the bubbler fluid feed hole 124 into the stand pipe 104-2, in response to the back pressure of the printhead 100 reaching a threshold level. The selected dimension of the bubbler orifice 120 can be based on test data or expert knowledge indicating a dimension of the bubbler orifice 120 that would allow air to bubble into the stand pipe 104-2 when the threshold back pressure level is reached. In other examples, a pressure sensitive valve may be provided as part of the bubbler 118, where the pressure sensitive valve can open in response to the back pressure reaching the threshold back pressure level.

FIG. 2 is a graph that illustrates a relationship of back pressure (represented by the vertical axis of the graph) of the printhead 100 as a function of delivered fluid volume (as represented by the horizontal axis of the graph). The delivered fluid volume represents the volume of fluid delivered from the fluid reservoir 104. As a result of use of the printhead 100, the amount of fluid delivered from the fluid reservoir 104 increases, which causes the back pressure to increase according to a first curve segment 202 shown in FIG. 2. The first curve segment 202 indicates that with increasing delivered fluid volume from the fluid reservoir 104, the back pressure increases exponentially while the bubbler 118 is not activated.

When the back pressure reaches a specified threshold level (represented by 204 in FIG. 2) after a volume of fluid has been delivered from the fluid reservoir 104, the bubbler 118 is activated to bubble air into the fluid reservoir 104. Bubbling air into the fluid reservoir 104 causes regulation of the back pressure to prevent a further rapid increase of the back pressure, as illustrated by a second curve segment 206.

FIG. 1 further shows a circulation path 126 formed in the chamber layer 114. The portion of the circulation path 126 shown in dotted profile indicates that the portion of the circulation path 126 is actually not visible in the cross section shown in FIG. 1, but would be present in a different cross section. The circulation path 126 is used to allow fluid to circulate through the bubbler chamber 122 to keep fluid in the bubbler chamber 122 fresh so that a soft viscous plug does not form in the bubbler chamber 122. Avoiding the formation of a soft viscous plug in the bubbler chamber 122 allows for the bubbler 118 to continue to function in the intended manner, and avoids the decap issue discussed further above.

As further shown in FIG. 1, nozzle fluid feedholes 130 are provided in the die layer 112 to deliver fluid from the fluid slot 128 to respective nozzles including fluid chambers in the chamber layer 114.

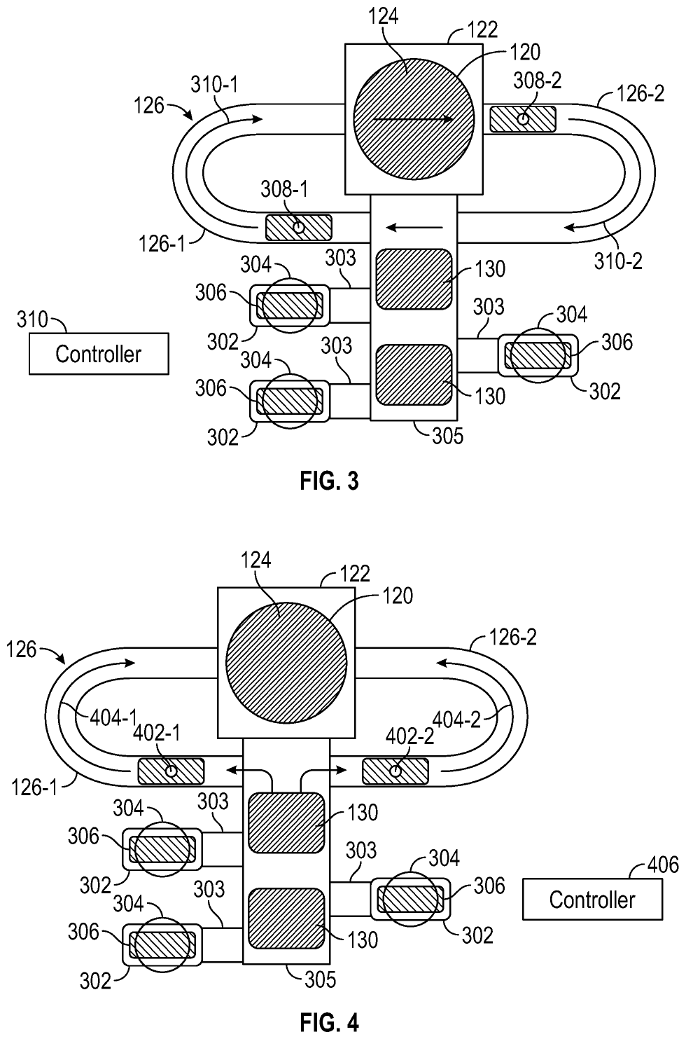

FIG. 3 is a schematic bottom view of a portion of a nozzle array and a bubbler, according to some implementations of the present disclosure. FIG. 3 shows the bubbler orifice 120 (in the orifice layer 116), the bubbler chamber 122 (in the chamber layer 114) that is in fluid communication with the bubbler orifice 120, and the bubbler fluid feed hole 124 (in the die layer 112) that is in fluid communication with the bubbler chamber 122.

In addition, FIG. 3 shows the bubbler circulation path 126 that is formed in the chamber layer 114.

FIG. 3 shows the nozzle fluid feed holes 130 formed in the die layer 112. The nozzle fluid feed holes 130 allow fluid from the fluid slot 128 (FIG. 1) to flow to fluid chambers 302 through respective fluid channels 305 and 303 formed in the chamber layer 114.

FIG. 3 also shows a nozzle orifice 304 associated with each corresponding fluid chamber 302. The nozzle orifices 304 are formed in the orifice layer 116.

FIG. 3 further shows a fluidic actuator 306 associated with each fluid chamber 302. Activation of a respective fluidic actuator 306 causes fluid to be dispensed from the corresponding fluid chamber 302 through the corresponding nozzle orifice 304. The fluidic actuators 306 are firing fluidic actuators that cause fluid to be ejected through the corresponding nozzle orifices 304. The fluidic actuators 306 can be implemented using resistive heaters (e.g., electrical resistors) or piezoelectric elements, for example.

Fluidic actuators 308-1 and 308-2 are provided in or adjacent the circulation path 126. The fluidic actuator 308-1 is provided in or adjacent a first circulation path portion 126-1 of the circulation path 126, and the fluidic actuator 308-2 is provided in or adjacent a second circulation path portion 126-2 of the circulation path 126. In some examples, the fluidic actuators 308-1 and 308-2 can be implemented using resistive heaters (e.g., electrical resistors). In other examples, the fluidic actuators 308-1 and 308-2 can be implemented using piezoelectric elements.

In examples where the fluidic actuators 308-1 and 308-2 are implemented as resistive heaters, activation of the resistive heaters causes fluid in the circulation path 126 to heat up to vaporize the fluid, which creates a bubble that drives and pumps adjacent fluid along the circulation path 126. In other examples, if the fluidic actuators 308-1 and 308-2 are implemented using piezoelectric elements, then activation of the piezoelectric elements causes deflection to force movement of the fluid in the circulation path 126.

In the example of FIG. 3, the fluidic actuator 308-1 and 308-2 act as pumps that pump fluid to flow in a generally clockwise direction through the circulation path 126, as indicated by arrows 310-1 and 310-2. The flow of fluid in the circulation path 126 causes fluid to pass through the bubbler chamber 122 and a portion of channel 305. The circulation of fluid in the circulation path 126 maintains freshness of the fluid in the bubbler chamber 122, to prevent formation of a soft viscous plug that can interfere with operation of the bubbler 118.

Activation of the fluidic actuators 308-1 and 308-2 can be controlled by a controller 310, which can be part of the printhead 100 or in a printing system such that the controller 310 is separate from the printhead 100, but is electrically connected to the printhead 100.

As used here, a “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

Although two fluidic actuators 308-1 and 308-2 are shown to pump fluid through the circulation path 126 in the example of FIG. 3, it is noted that a different number of fluidic actuators for pumping fluid through the circulation path 126 can be used in other examples.

FIG. 4 illustrates a different example in which fluidic actuators 402-1 and 402-2 for the circulation path 126 causes fluid to flow into the bubbler chamber 120 in opposing directions. The fluidic actuator 402-1 causes fluid to flow in a first loop direction indicated by an arrow 404-1 in the first circulation path portion 126-1, which causes fluid to flow into the left side of the bubbler chamber 120 (in the view of FIG. 4) from the first circulation path portion 126-1. The fluidic actuator 402-2 causes fluid to flow in a second loop direction indicated by an arrow 404-2 in the second circulation path 126-2, which causes fluid to flow into the right side of the bubbler chamber 120 (in the view of FIG. 4) from the second circulation path portion 126-2. The fluidic actuators 402-1 and 402-2 can draw fluid through the nozzle fluid feed holes 130 to provide the flow in the respective circulation path portions 126-1 and 126-2.

Activation of the fluidic actuators 402-1 and 402-2 can be controlled by a controller 406, which can be part of the printhead 100 or in a printing system such that the controller 406 is separate from the printhead 100, but is electrically connected to the printhead 100.

Although two fluidic actuators 402-1 and 402-2 are shown to pump fluid through the circulation path 126 in the example of FIG. 4, it is noted that a different number of fluidic actuators for pumping fluid through the circulation path 126 can be used in other examples.

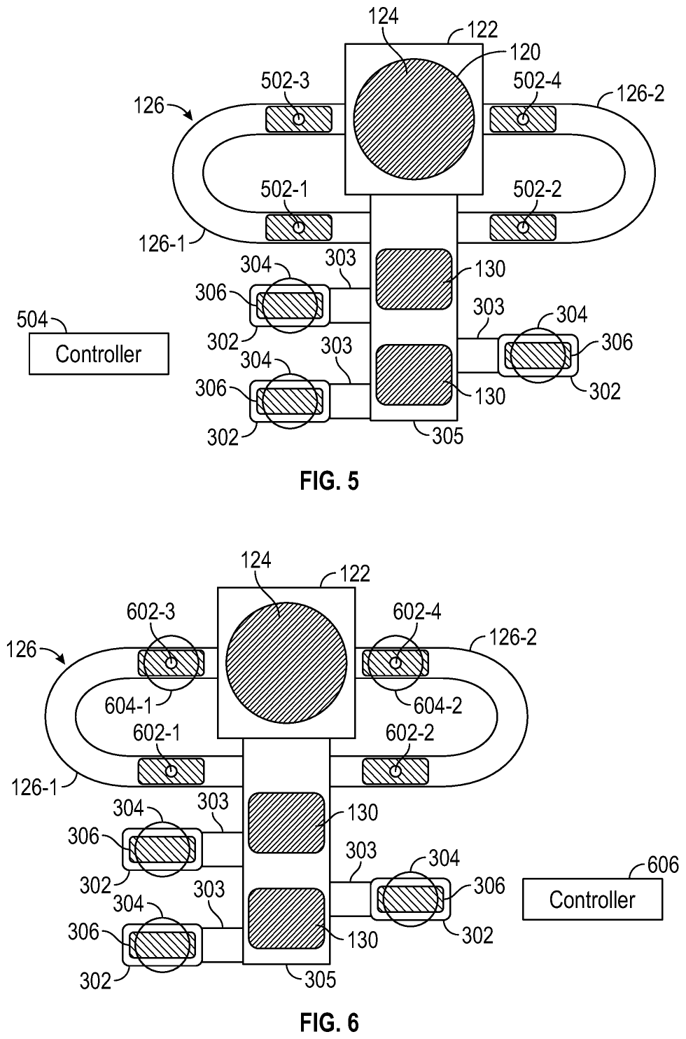

FIG. 5 illustrates yet a further example in which four fluidic actuators 502-1, 502-2, 502-3, and 502-4 are provided in or adjacent the circulation path 126. The fluidic actuators 502-1, 502-2, 502-3, and 502-4 can be selectively activated and deactivated. For example, if the fluidic actuators 502-1 and 502-4 are activated (but the fluidic actuators 502-2 and 502-3 are deactivated), then the arrangement of FIG. 5 can provide flow in the circulation path 126 according to the flow shown in FIG. 3. On the other hand, if the fluidic actuators 502-1 and 502-2 are activated (but the fluidic actuators 502-3 and 502-4 are deactivated), then the arrangement of FIG. 5 can provide fluid flow in the circulation path 126 according to the flow shown in FIG. 4.

Selective activating and deactivating of the fluidic actuators 502-1, 502-2, 502-3, and 502-4 can be performed by a controller 504, which can be part of the printhead 100 or in a printing system such that the controller 504 is separate from the printhead 100, but is electrically connected to the printhead 100.

Although four fluidic actuators 502-1, 502-2, 502-3, and 502-4 are shown to pump fluid through the circulation path 126 in the example of FIG. 5, it is noted that a different number of fluidic actuators for pumping fluid through the circulation path 126 can be used in other examples.

FIG. 6 shows yet a further example that includes fluidic actuators 602-1, 602-2, 602-3, and 602-4. The fluidic actuator 602-1 and 602-2 are pumps that cause fluid flow in the circulation path 126, such as according to the flow shown in FIG. 4. The fluidic actuators 602-3 and 602-4 are firing fluidic actuators that cause fluid to be dispensed through respective orifices 604-1 and 604-2. The orifices 604-1 and 604-2 are formed in an orifice layer 116 and are part of the bubbler 118 of FIG. 1. The orifices 604-1 and 604-2 are firing orifices that allow for fluid droplets to be ejected from the circulation path 126 in a vertical direction of the printhead die 108, which can be performed during servicing of the bubbler 118, such as to eject fluid if it is determined that the bubbler 118 is not functioning in a target manner. The vertical direction of the printhead die 108 is perpendicular to the plane that includes the circulation path 126.

Selective activating and deactivating of the fluidic actuators 602-1, 602-2, 602-3, and 602-4 can be performed by a controller 606, which can be part of the printhead 100 or in a printing system such that the controller 606 is separate from the printhead 100, but is electrically connected to the printhead 100.

Although four fluidic actuators 602-1, 602-2, 602-3, and 602-4 are shown in the example of FIG. 6, it is noted that a different number of fluidic actuators for pumping fluid through the circulation path 126 and/or ejecting fluid through orifices from the circulation path 126 can be used in other examples.

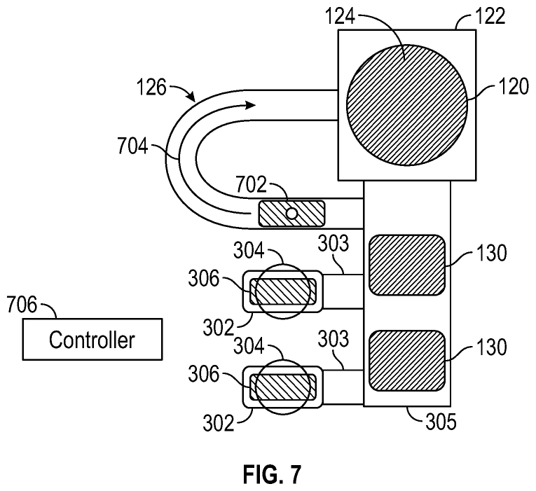

FIG. 7 is an example in which the circulation path 126 extends only on one side of the bubbler chamber 122. A fluidic actuator 702 is provided in or adjacent the circulation path 126 to cause a flow fluid along a loop direction represented by arrow 704 into the bubbler chamber 122.

Activation of the fluidic actuator 702 can be controlled by a controller 706, which can be part of the printhead 100 or in a printing system such that the controller 706 is separate from the printhead 100, but is electrically connected to the printhead 100.

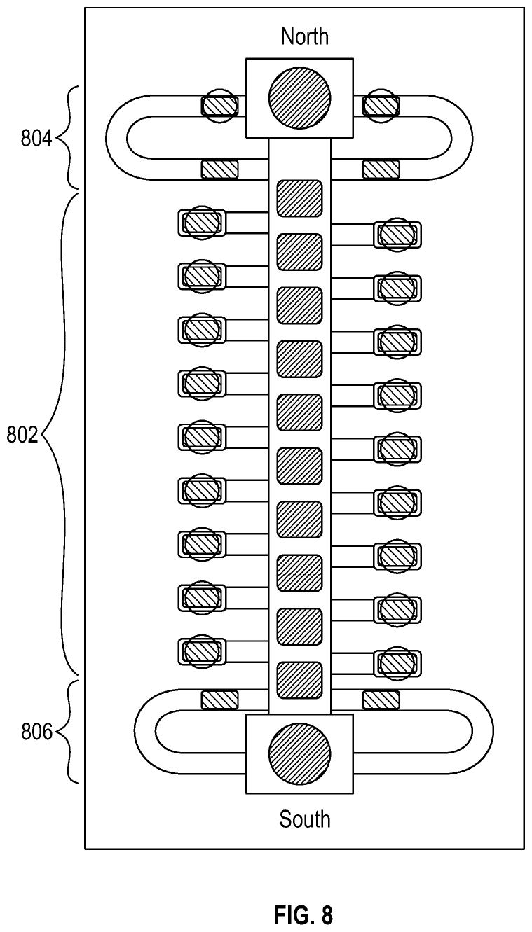

FIG. 8 illustrates a further example that includes an array of nozzles 802 including respective nozzle orifices, fluid chambers, and fluidic actuators. In addition, FIG. 8 shows bubblers 804 and 806 provided at two different ends (marked as north and south in FIG. 8) of the nozzle array 802. Each bubbler 804 and 806 includes the respective bubbler orifice, bubbler chamber, bubbler fluid feed hole, circulation path, and fluidic actuator(s) as discussed above.

Each of the bubblers 804 and 806 can be implemented using any of the arrangements shown in FIGS. 3-7. Moreover, in alternative examples, the bubbler 804 or the bubbler 806 can be omitted.

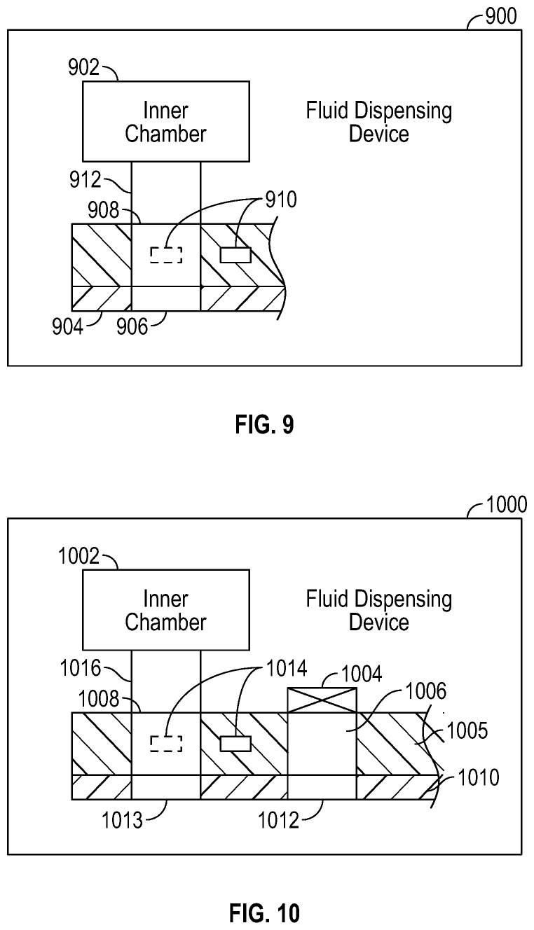

FIG. 9 is a block diagram of a fluid dispensing device 900 that includes an inner chamber 902 to contain a fluid. For example, the inner chamber 902 can include the stand pipe 104-2 of FIG. 1. In another example, the inner chamber 902 can be part of another fluid reservoir in the fluid dispensing device 900.

The fluid dispensing device 900 includes an orifice layer 904 that includes a bubbler orifice 906 to draw air through a bubbler chamber 908 to the inner chamber 902, in response to a pressure satisfying a criterion. The bubbler chamber 908 is adjacent the bubbler orifice 906.

The fluid dispensing device 900 further includes a circulation path 910 to circulate fluid, drawn through a feed hole 912, through the bubbler chamber 908.

In further examples, the fluid dispensing device 900 includes a fluid pump to cause movement of the fluid in the circulation path 910. The fluid pump can include a resistive heater or a piezoelectric element to cause the movement of the fluid in the circulation path 910.

FIG. 10 is a block diagram of a fluid dispensing device 1000 according to further examples. The fluid dispensing device 1000 includes an inner chamber 1002 (e.g., the stand pipe 104-2) to contain a fluid. The fluid dispensing device 1000 further includes a fluidic actuator 1004, a chamber layer 1005 including a nozzle chamber 1006 and a bubbler chamber 1008.

The fluid dispensing device 1000 further includes an orifice layer 1010 including a nozzle orifice 1012 to dispense fluid in the nozzle chamber 1006 through the nozzle orifice 1012 responsive to actuation of the fluidic actuator 1004.

The orifice layer 1010 further includes a bubbler orifice 1013 to draw air through the bubbler chamber 1008 to the inner chamber 1002 responsive to a pressure satisfying a criterion.

The fluid dispensing device 1000 additionally includes a circulation path 1014 to circulate fluid, drawn through a feed hole 1016, through the bubbler chamber 1008 adjacent the bubbler orifice 1013. Fluid flow in the circulation path 1014 refreshes the fluid in the bubbler chamber 1008.

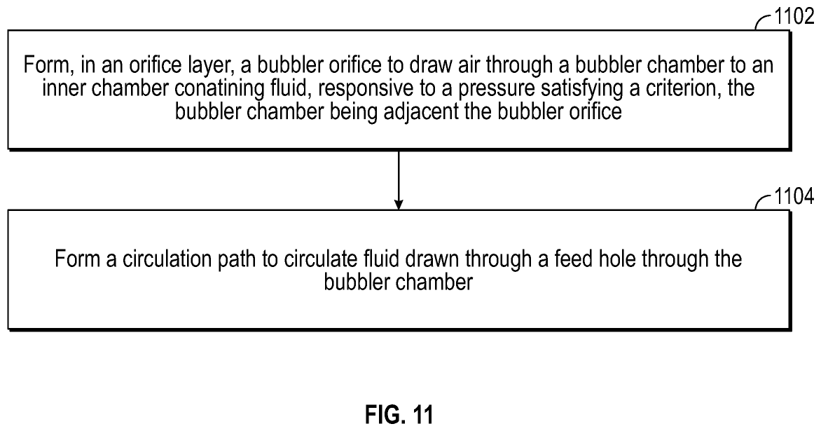

FIG. 11 is a flow diagram of a process of forming a fluid dispensing device, according to some examples.

The process includes forming (at 1102), in an orifice layer, a bubbler orifice to draw air through a bubbler chamber to an inner chamber containing fluid, responsive to a pressure satisfying a criterion, the bubbler chamber being adjacent the bubbler orifice.

The process further includes forming (at 1104) a circulation path to circulate fluid drawn through a feed hole through the bubbler chamber.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A fluid dispensing device comprising:
an inner chamber to contain a fluid;
an orifice layer comprising a bubbler orifice to draw air through a bubbler chamber to the inner chamber responsive to a pressure satisfying a criterion, the bubbler chamber being adjacent the bubbler orifice; and
a circulation path to circulate fluid drawn through a feed hole through the bubbler chamber.

2. The fluid dispensing device of claim 1, further comprising a fluid pump to cause movement of the fluid in the circulation path.

3. The fluid dispensing device of claim 2, wherein the fluid pump comprises a fluidic actuator to cause the movement of the fluid in the circulation path.

4. The fluid dispensing device of claim 1, wherein the circulation path is on one side of the bubbler chamber.

5. The fluid dispensing device of claim 1, wherein the circulation path comprises a first path portion on a first side of the bubbler chamber, and a second path portion on a second side of the bubbler chamber.

6. The fluid dispensing device of claim 5, further comprising a first fluid pump in the first path portion, and a second fluid pump in the second path portion.

7. The fluid dispensing device of claim 6, wherein the first fluid pump is cause fluid movement along a first loop direction, and the second fluid pump is cause fluid movement along the first loop direction.

8. The fluid dispensing device of claim 6, wherein the first fluid pump causes fluid movement along a first loop direction, and the second fluid pump causes fluid movement along a second loop direction opposite the first loop direction.

9. The fluid dispensing device of claim 1, further comprising a plurality of fluid pumps in the circulation path, the plurality of fluid pumps selectively activatable such that a first fluid pump of the plurality of fluid pumps is activated while a second fluid pump of the plurality of fluid pumps is deactivated.

10. The fluid dispensing device of claim 1, further comprising:
a fluidic actuator and a firing orifice in the orifice layer, the firing orifice to dispense a fluid droplet responsive to activation of the fluidic actuator.

11. A fluid dispensing device comprising:
an inner chamber to contain a fluid;
a fluidic actuator;
a chamber layer comprising a nozzle chamber and a bubbler chamber;
an orifice layer comprising:
a nozzle orifice to dispense fluid in the nozzle chamber through the nozzle orifice responsive to actuation of the fluidic actuator, and
a bubbler orifice to draw air through the bubbler chamber to the inner chamber responsive to a pressure satisfying a criterion; and
a circulation path to circulate fluid drawn through a feed hole through the bubbler chamber adjacent the bubbler orifice, the circulation path to refresh the fluid in the bubbler chamber.

12. The fluid dispensing device of claim 11, further comprising:
a plurality of pumps selectively activatable and de-activatable to control fluid flow in the circulation path.

13. The fluid dispensing device of claim 11, further comprising:
a fluid slot, wherein the circulation path is to circulate the fluid drawn through the feed hole from the fluid slot; and
a further feed hole to supply fluid from the fluid slot to the nozzle chamber.

14. A method of forming a fluid dispensing device, comprising:
forming, in an orifice layer, a bubbler orifice to draw air through a bubbler chamber to an inner chamber containing fluid, responsive to a pressure satisfying a criterion, the bubbler chamber being adjacent the bubbler orifice; and
forming a circulation path to circulate fluid drawn through a feed hole through the bubbler chamber.

15. The method of claim 14, further comprising:
forming, in the orifice layer, a nozzle orifice to dispense a fluid droplet responsive to activation of a fluidic actuator.
